(19) United States
(12) Patent Application Publication
(10) Pub. No.: US 2025/0193484 A1
(43) Pub. Date: Jun. 12, 2025

(54) REFRIGERATOR AND CONTROLLING METHOD THEREOF

(71) Applicant: SAMSUNG ELECTRONICS CO., LTD., Suwon-si (KR)

(72) Inventor: Seokjung YOON, Suwon-si (KR)

(73) Assignee: SAMSUNG ELECTRONICS CO., LTD., Suwon-si (KR)

(21) Appl. No.: 19/059,905

(22) Filed: Feb. 21, 2025

Related U.S. Application Data
(63) Continuation of application No. PCT/KR2023/014153, filed on Sep. 19, 2023.

(30) Foreign Application Priority Data
Oct. 12, 2022 (KR) 10-2022-0130970

(51) Int. Cl. H04N 21/433; F25D 23/02; H04N 21/2187; H04N 21/44; H04N 21/443

(52) U.S. Cl. CPC H04N 21/4333; F25D 23/028; H04N 21/2187; H04N 21/44008; H04N 21/4436

(57) ABSTRACT

A refrigerator includes a main body including a storage compartment, at least one door coupled to the main body to open or close the storage compartment, a display configured to display content, the at least one door having the display, a door sensor configured to detect whether the at least one door is opened or closed, and a processor configured to determine whether the content being played on the display is a stop target in response to detecting that the at least one door is opened; pause the content being played in response to determining that the content being played is the stop target, and resume playing the paused content from a paused point in response to detecting that the at least one door closed.

### CROSS REFERENCE TO THE RELATED APPLICATION

This application is a continuation application, filed under 35 U.S.C. § 111 (a), of International Application PCT/KR2023/014153 filed Sep. 19, 2023, and is based on and claims priority under 35 U.S.C. § 119 to Korean Patent Applications No. 10-2022-0130970, filed on Oct. 12, 2022, in the Korean Intellectual Property Office, the disclosures of which are incorporated by reference herein in their entireties.

### TECHNICAL FIELD

The disclosure relates to a refrigerator and a method for controlling the same, and more particularly, to a refrigerator having a display and a method for controlling the same.

### BACKGROUND ART

A refrigerator is a device that uses a refrigeration cycle to keep items such as food fresh, and may include a freezing compartment for storing items under zero temperatures and a refrigerating compartment for storing items at above freezing temperatures.

In addition, the refrigerator may be provided with a display in an area of a door to play a video about a cooking recipe or to play a live video.

In a case where a user opens and closes the door equipped with the display while watching a video on the display, the watching of the video is interrupted.

### DISCLOSURE

### Technical Problem

An aspect of the disclosure provides a refrigerator and a method for controlling the same that may detect opening and closing of a door equipped with a display, and pause and play an image displayed on the display based on the detection result.

Another aspect of the disclosure provides a refrigerator and a method for controlling the same that may determine whether an image displayed on a display is a stop target to pause and then play the image.

### Technical Solution

According to an embodiment, a refrigerator may include: a main body including a storage compartment; at least one door coupled to the main body to open and close the storage compartment; a display provided on an area of the at least one door and configured to display content; a door sensor configured to detect whether the at least one door is opened or closed; and a processor configured to: determine whether the content played on the display is a stop target based on the at least one door being opened; pause the content based on the content being the stop target; and play the content from a paused point based on the at least one door being closed.

The processor may be configured to determine whether the content is a real-time video, and determine the content as the stop target based on the content not being the real-time video.

The refrigerator may further include memory configured to store the content, wherein the processor may be configured to determine that the content is not the real-time video, based on the content being stored in the memory.

The processor may be configured to determine that the content is the real-time video, based on playback data of the content including reference data.

The processor may be configured to switch the display to a power saving mode, based on the content being the real-time video and the at least one door being opened.

The processor may be configured to determine whether the content includes a video, and determine that the content as the stop target based on the content including the video.

The processor may be configured to determine that the content as the stop target, based on an amount of pixel data change of the content including the video being greater than or equal to a reference value.

The processor may be configured to determine that the display is abnormally terminated, based on the display being turned off in a state where the at least one door is closed.

The processor may be configured to store playback data at an end time point of the content in the memory, based on the display being abnormally terminated.

The processor may be configured to determine whether the content is the stop target based on the playback data, and play the content from the end time point based on the content being the stop target and the at least one door being closed.

According to an embodiment, in a method for controlling a refrigerator including a main body including a storage compartment, at least one door coupled to the main body to open and close the storage compartment, a display provided on an area of the at least one door and configured to display content, and a door sensor configured to detect whether the at least one door is opened or closed, the method may include: determining whether the content played on the display is a stop target based on the at least one door being opened; pausing the content based on the content being the stop target; and playing the content from a paused point based on the at least one door being closed.

The determining of whether the content is the stop target may determine whether the content is a real-time video, and determines the content as the stop target based on the content not being the real-time video.

The determining of whether the content is the real-time video may determine that the content is not the real-time video, based on the content being stored in a memory.

The determining of whether the content is the real-time video may determine that the content is the real-time video, based on playback data of the content including reference data.

The method may further include switching the display to a power saving mode, based on the content being the real-time video and the at least one door being opened.

The determining of whether the content is the stop target may determine whether the content includes a video, and determine that the content as the stop target based on the content including the video.

The determining of whether the content is the stop target may determine that the content as the stop target, based on an amount of pixel data change of the content including the video being greater than or equal to a reference value.

The method may further include determining that the display is abnormally terminated, based on the display being turned off in a state where the at least one door is closed.

The method may further include storing playback data at an end time point of the content in the memory, based on the display being abnormally terminated.

The method may further include determining whether the content is the stop target based on the playback data, and playing the content from the end time point based on the content being the stop target and the at least one door being closed.

### Advantageous Effects

According to an embodiment, a user of a refrigerator may use a door equipped with a display without having to stop an image being displayed, thereby increasing user convenience.

In addition, a refrigerator according to an embodiment may turn off a display in response to an opening of a door equipped with the display, thereby reducing power loss.

### DESCRIPTION OF DRAWINGS

FIG. 1 is a view illustrating an exterior of a refrigerator having a display according to an embodiment.

FIG. 2 is a view illustrating an interior of a refrigerator according to an embodiment.

FIG. 3 is a control block diagram of a refrigerator according to an embodiment.

FIG. 4 is a view illustrating a live video is played on a display of a refrigerator according to an embodiment.

FIG. 5 is a flowchart illustrating operations of determining whether a live video is played on a display of a refrigerator according to an embodiment.

FIG. 6 is a flowchart illustrating operations of determining whether the live video is played on the display of the refrigerator according to an embodiment, in continuation from FIG. 5.

FIG. 7 is a view illustrating audio is played on a display of a refrigerator according to an embodiment.

FIG. 8 is a flowchart illustrating operations of determining whether a video is played on a display of a refrigerator according to an embodiment.

FIG. 9 is a view illustrating a change in image content displayed on a display of a refrigerator according to an embodiment.

FIG. 10 is a flowchart illustrating operations of determining whether content of an image displayed on a display of a refrigerator is changed according to an embodiment.

FIG. 11 is a view illustrating an abnormal termination of a display of a refrigerator according to an embodiment.

FIG. 12 is a flowchart illustrating operations of playing a video in a case where a display of a refrigerator is abnormally terminated according to an embodiment.

FIG. 13 is a flowchart illustrating operations of playing the video in the case where the display of the refrigerator is abnormally terminated according to an embodiment, in continuation from FIG. 12.

### MODE FOR INVENTION

Embodiments described in the disclosure and configurations shown in the drawings are merely examples of the embodiments of the disclosure, and may be modified in various different ways at the time of filing of the application to replace the embodiments and drawings of the disclosure.

In addition, like reference numerals throughout the disclosure denote like elements.

In addition, terms used herein are for describing embodiments only and are not intended to limit the disclosure. The singular form of a noun corresponding to an item may include one or more of the items unless clearly indicated otherwise in a related context. It will be understood that the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

Although the terms “first”, “second”, etc. may be used to describe various components, the terms do not limit the corresponding components, but are used only for the purpose of distinguishing one component from another. For example, without departing from the technical spirit of the disclosure, a first element may be referred to as a second element, and a second element may be referred to as a first element. The term “and/or” includes any and all combinations of one or more of the associated listed items.

In addition, the terms “portion”, “device”, “block”, “member”, and “module” used herein refer to a unit for processing at least one function or operation. For example, the terms may mean at least one process that may be processed by at least one hardware such as field-programmable gate array (FPGA) or application specific integrated circuit (ASIC), or at least one software or processor stored in a memory.

Reference numerals used for method steps are simply used for convenience of explanation, but not to limit an order of the steps. Thus, unless the context clearly dictates otherwise, the written order may be practiced otherwise.

Hereinafter, a refrigerator and a method for controlling the same according to the disclosure are described in detail with reference to the accompanying drawings.

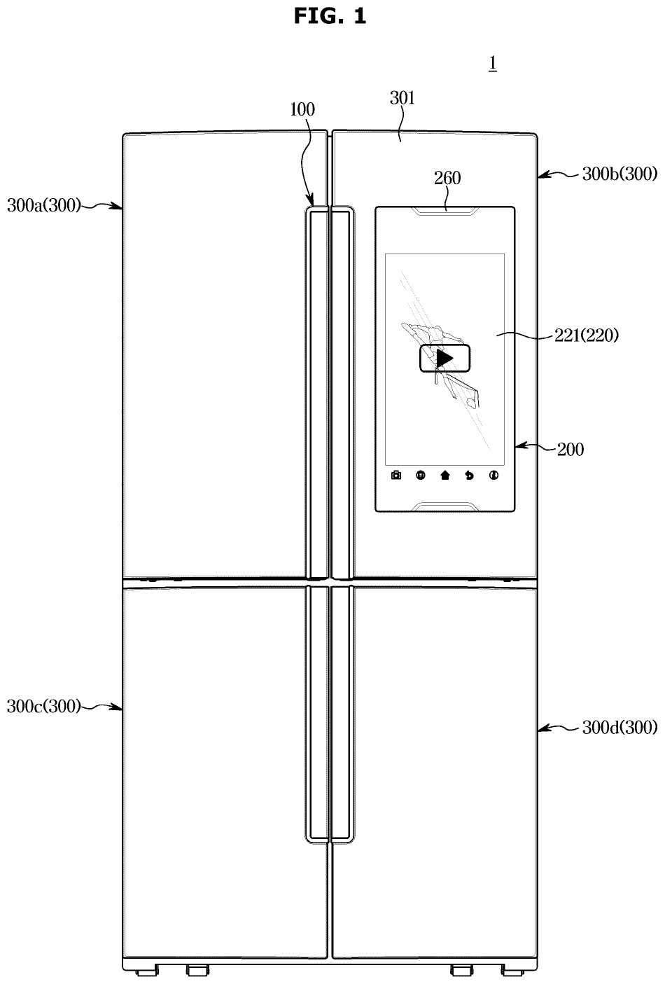

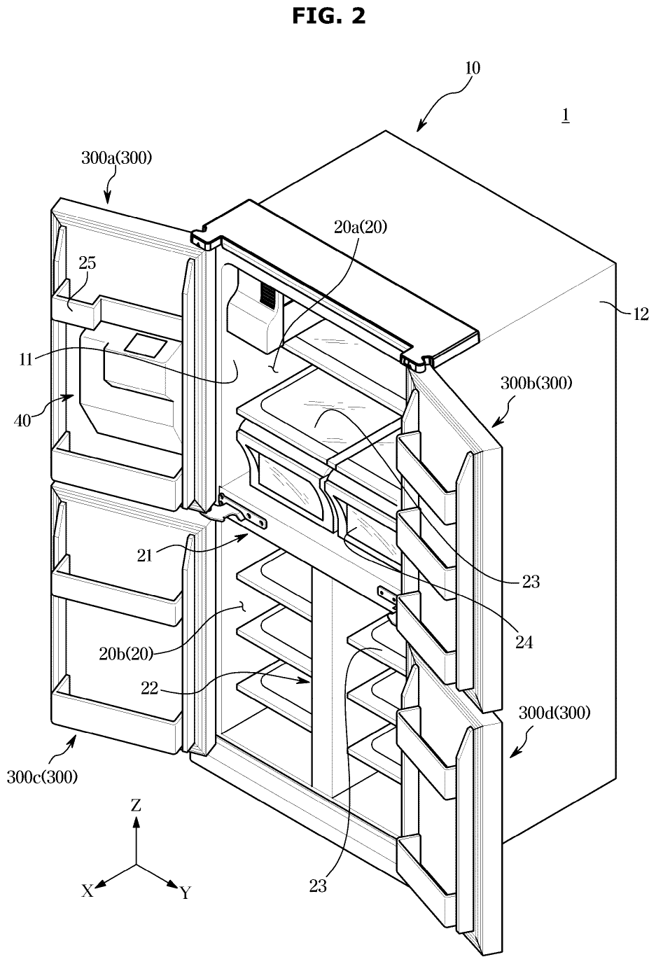

FIG. 1 is a view illustrating an exterior of a refrigerator having a display according to an embodiment. FIG. 2 is a view illustrating an interior of a refrigerator according to an embodiment.

A refrigerator 1 may include a main body 10, a storage compartment provided inside the main body 10 to allow a front side to be opened, and a door 300 rotatably coupled to the main body 10 to open and close the front side of the storage compartment.

The main body 10 may form an exterior of the refrigerator 1. The main body 10 may include an inner case 11 forming the storage compartment, and an outer case 12 coupled to an outside of the inner case 11 to form the exterior. In addition, the main body 10 may further include a cold air supply device (not shown) for supplying cold air to the storage compartment.

The cold air supply device may include a compressor, a condenser, an expansion valve, an evaporator, a blower fan, a cold air duct, and the like. An insulating material (not shown) may be filled between the inner case 11 and the outer case 12 of the main body 10 to prevent cold air from leaking out of the storage compartment.

A machine compartment (not shown) may be provided at a lower rear side of the main body 10 and may include a compressor for compressing refrigerant and a condenser for condensing the compressed refrigerant.

The storage compartment may be divided into a plurality of sections by a horizontal partition wall 21 and a vertical partition wall 22. In the embodiment, the storage compartment may include an upper storage compartment 20a and a lower storage compartment 20b. The storage compartment may be provided with a shelf 23 on which food may be placed and a storage container 24 for storing food. The storage compartment may be provided with the front side open to allow food to be taken in and out, and the front side may be opened and closed by the door 300.

The upper storage compartment 20a may be opened and closed by a plurality of doors 300a and 300b. The lower storage compartment 20b may be opened and closed by a plurality of doors 300c and 300d.

The refrigerator 1 may further include a handle 100 provided on the door 300. A user may easily open and close the door 300 by holding the handle 100. The handle 100 may be elongated along a vertical direction Z of the door 300.

The refrigerator 1 may further include a dispenser (not shown). The dispenser may be installed in the door 300. For example, the dispenser may be installed in the left upper door 300a. A user may use the dispenser to directly take out water or ice without opening the door 300a. The dispenser may include a cavity formed inside of the door 300a. The cavity may be provided with a dispensing port through which water or ice is dispensed, and a dispensing lever for dispensing water or ice. By pressing the dispensing lever, water or ice is dispensed from the dispensing port. The dispenser may further include a dispenser state display that displays an operating state of the dispenser. The dispenser state display may also have a touch function.

The refrigerator 1 may further include a display 200.

The display 200 may be installed on the door 300 for user convenience. Specifically, the display 200 may be installed on a front surface 301 of the door 300.

Although the display 200 is shown as being installed on the right upper door 300b, the location of the display 200 is not limited to the right upper door 300b and the display 200 may be located on any side of the door 300. However, an example in which the display 200 is installed on the right upper door 300b is described below.

An upper end of the display 200 may be at the same position as an upper end of the handle 100 in the vertical direction Z of the door 300. A lower end of the display 200 may be at the same position as a lower end of the dispenser 40 in the vertical direction Z of the door 300. One side end of the display 200 adjacent to the handle 100 may be spaced apart from the handle 100 by a predetermined distance. The other side end opposite to the one side end of the display 200 adjacent to the handle 100 may be spaced apart from an edge of the door 300 by a predetermined distance.

In other words, the display 200 may have a rectangular shape having a long side in the vertical direction Z of the door 300. The display 200 may have a right long side toward the right side of the door 300, a left long side toward the left side of the door 300, an upper short side toward the upper side of the door 300, and a lower short side toward the lower side of the door 300.

The right long side may be spaced apart from a right edge of the door 300 by a predetermined distance in the left direction of the door 300. The left long side may be spaced apart from the handle 100 by a predetermined distance in the right direction of the door 300. The upper short side may be at the same position as the upper end of the handle 100 in the vertical direction Z of the door 300. The lower short side may be at the same position as the lower end of the dispenser 40 in the vertical direction Z of the door 300.

With the arrangement of the display 200 as described above, a clean and stable design of the refrigerator 1 may be realized.

The display 200 may include a display panel 220 and a touch panel 221. Alternately, the display 200 may include only the display panel 220.

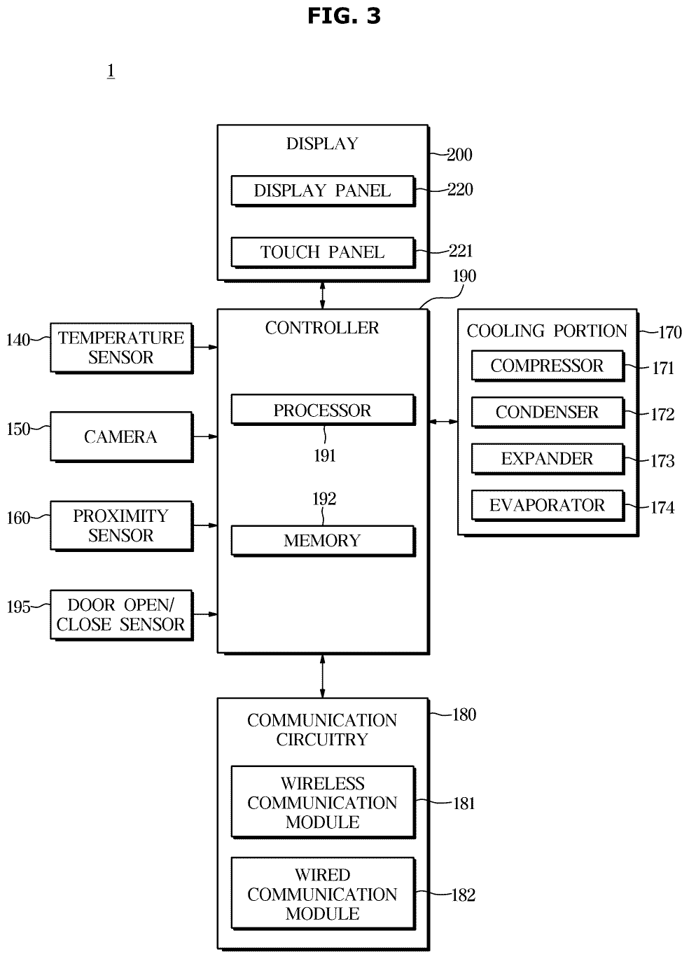

The display 200 may be equipped with a wake-up function that is automatically activated when a user approaches within a predetermined range. The wake-up function may be implemented through a proximity sensor 160 (see FIG. 3).

Specifically, as shown in FIG. 2, in a case where the proximity sensor 160 detects the approach of a user within the predetermined range, the display 200 is activated. That is, the display 200 is turned on. In contrast, as shown in FIG. 1, in a case where the proximity sensor 160 does not detect the approach of the user within the predetermined range, the display 200 is not activated. That is, the display 200 remains in an off state. When the display 200 is activated, various images or videos may be displayed on the display 200.

The display 200 may be provided with a function to pause a video and turn off the display 200 when a user opens the door equipped with the display 200.

In addition, the display 200 may be provided with a function to turn on the display 200 and play the video when the user closes the door equipped with the display 200.

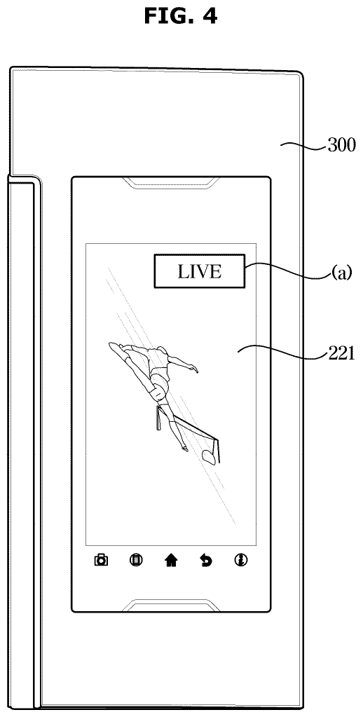

The power on/off function may be implemented by a door open/close sensor 195 (see FIG. 3), which will be described in detail with reference to FIG. 4.

The display 200 may include the display panel 220. The display 200 may include a liquid crystal display (LCD).

The display panel 220 may be located on the front surface of the display. The touch panel 221 may be formed on the display panel 220.

A user may touch the touch panel 221 as shown in FIG. 1 to play or pause a video.

The touch panel 221 may be implemented as a capacitive or resistive type.

However, a method of forming the touch panel 221 is not limited to the above example.

At least one input user interface (UI) component may be provided on the display panel 220. The at least one input UI component may include, for example, a camera UI component for executing a camera 150 (see FIG. 3), a list UI component for various lists related to the functions of the refrigerator 1, a home UI component for returning to a home screen, a back UI component for returning to a previous screen, an information-providing UI component for providing information about overall functions of the refrigerator 1 or the overall functions of the display 200, and the like.

The at least one input UI component may be formed on the display panel 220. Preferably, the at least one input UI component may be formed on an outer area of the display panel 220 so as not to interfere with an image or video displayed on the display 200.

The refrigerator 1 may further include the camera 150 capable of photographing a person and an object. Images or videos captured by the camera 150 may be displayed on the display 200.

The refrigerator 1 may further include at least one microphone for a voice recognition function. A voice command input through the microphone may be transmitted to a processor 191 (see FIG. 3), and the processor 191 may control the display 200 to display a result of the voice command.

The refrigerator 1 may further include an illuminance sensor. The illuminance sensor may adjust a brightness of the display to be bright in a bright place and dim in a dark place, thereby reducing a power loss of the refrigerator 1. A detection result of the illuminance sensor may be transmitted to the processor 191, and the processor 191 may control the display panel 220 to adjust the illuminance of the display 200.

The refrigerator 1 may include the door open/close sensor 195. The door open/close sensor 195 may be provided on a hinge (not shown) that couples the door 300 and the main body 10, or may be provided on a portion of the door 300 or a portion of the main body 10 where the door 300 and the main body 10 come into contact.

At least one of the proximity sensor 160, the camera 150, the at least one microphone, or the illuminance sensor may be disposed behind the display panel 220. The at least one of the proximity sensor 160, the camera 150, the at least one microphone, or the illuminance sensor may be disposed in front of a display case facing the display panel 220.

FIG. 3 is a control block diagram of a refrigerator according to an embodiment.

Referring to FIG. 3, the refrigerator 1 may include the display 200, a temperature sensor 140, the camera 150, the proximity sensor 160, the door open/close sensor 195, a cooling portion 170, communication circuitry 180, and a controller 190.

The temperature sensor 140 may include a plurality of temperature sensors installed inside the storage compartment 20 to detect a temperature inside the storage compartment 20.

The plurality of temperature sensors may each be installed in each of the plurality of storage compartments 20 to detect the temperature of each of the plurality of storage compartments 20, and may output an electrical signal corresponding to the detected temperature to the controller 190. Each of the plurality of temperature sensors may include a thermistor whose electrical resistance changes depending on the temperature.

The door open/close sensor 195 may output whether the door 300 is opened as a preset determination value, as described above. For example, the door open/close sensor 195 may output 1 in response to the door 300 being opened, and may output 0 in response to the door 300 being closed.

The door open/close sensor 195 may also be implemented as a distance sensor. Based on a distance between the door 300 and the main body being greater than or equal to a reference distance, the door open/close sensor 195 may determine that the door 300 is opened, and based on the distance being less than the reference distance, the door open/close sensor 195 may determine that the door 300 is closed.

However, the door open/close sensor 195 is not limited thereto, and any configuration of sensor may be used as long as it may determine whether the door 300 is opened and may output a preset determination value.

The cooling portion 170 may supply cold air to the storage compartment. Specifically, the cooling portion 170 may maintain a temperature of the storage compartment within a range set by a user by using a circulation of refrigerant in a refrigerant circuit.

The cooling portion 170 may include a compressor 171 for compressing the gaseous refrigerant, a condenser 172 for converting the compressed gaseous refrigerant into a liquid state, an expander 173 for decompressing the liquid refrigerant, and an evaporator 174 for converting the decompressed liquid refrigerant into a gaseous state. The cooling portion 170 may cool the air in the storage compartment using a phenomenon in which the liquid refrigerant absorbs heat energy of the surrounding air during a phase change of the refrigerant from a liquid state to a gaseous state.

However, the cooling portion 170 is not limited to including the refrigerant circuit. For example, the cooling portion 170 may include a Peltier element using the Peltier effect or a magnetic cooling material using the magneto-caloric effect.

The communication circuitry 180 may exchange data with an external device such as a server device and/or a user device and/or the display 200 and/or a cooking appliance.

The communication circuitry 180 may include a wired communication module 182 that exchanges data with external devices by wire, and a wireless communication module 181 that exchanges data with external devices wirelessly.

The wired communication module 182 may access a wired communication network and communicate with external devices through the wired communication network. For example, the wired communication module 182 may access a wired communication network over Ethernet (IEEE 802.3 standard), and may receive data from external devices through the wired communication network.

The wireless communication module 181 may wirelessly communicate with a base station or an access point (AP), and may access a wired communication network through the base station or the access point. The wireless communication module 181 may also communicate with external devices connected to the wired communication network via the base station or the access point. For example, the wireless communication module 181 may wirelessly communicate with an access point (AP) using Wi-Fi (IEEE 802.11 standard), or may communicate with a base station using code division multiple access (CDMA), wideband code division multiple access (WCDMA), global system for mobile communication (GSM), long term evolution (LTE), WiBro, and the like. The wireless communication module 181 may receive data from external devices via the base station or the access point.

In addition, the wireless communication module 181 may communicate directly with external devices. For example, the wireless communication module 181 may wirelessly receive data from external devices using Wi-Fi, Bluetooth™ (IEEE 802.15.1 standard), ZigBee (IEEE 802.15.4 standard), and the like.

As such, the communication circuitry 180 may exchange data with external devices, and in particular, may receive video data including video and/or audio from the external devices, and may output the received data to the controller 190.

The controller 190 may process a user input and/or door open/close detection data and/or communication data, and may control the components of the refrigerator 1 based on the data processing.

The controller 190 may include memory 192 that stores/records a program and/or data, and a processor 191 that processes a user input and/or door open/close detection data and/or communication data according to the program and/or data stored in the memory 192.

The memory 192 may store/record a program and/or data. A program includes a plurality of instructions combined to perform a specific function, and data may be processed by a plurality of instructions included in the program. In addition, the program and/or data may include a system program and/or system data directly related to an operation of the refrigerator 1, and an application program and/or application data that provide convenience and fun to a user.

The memory 192 may include a non-volatile memory that stores a program and/or data for controlling the components of the refrigerator 1, and a volatile memory that stores temporary data generated while controlling the components of the refrigerator 1.

For example, the non-volatile memory may store programs and/or data electrically, magnetically, or optically. The non-volatile memory may include, for example, read only memory (ROM) and flash memory for long-term data storage. In addition, the non-volatile memory may include solid state drive (SSD), hard disc drive (HDD), optical disc drive (ODD), and the like.

For example, the volatile memory may load programs and/or data from non-volatile memory, and may electrically store programs and/or data. The volatile memory may include, for example, static random access memory (S-RAM) and dynamic random access memory (D-RAM), and the like for temporarily storing data.

The memory 192 may store/record programs and data such as an operating system (OS), middleware, and applications, and may provide the programs and data to the processor 191 in response to a request from the processor 191.

The processor 191 may process a user input on the display 200 and/or detection data of the proximity sensor 160 and/or communication data of the communication circuitry 180 according to the program and/or data stored/recorded in the memory 192. In addition, the processor 191 may generate a control signal for controlling an operation of the camera 150, the display 200, and/or the communication circuitry 180 based on the data processing.

For example, the processor 191 may determine whether content being played on the display 200 is a stop target based on the at least one door 300 being opened, may pause the content based on the content being the stop target, and may play the content from the paused point based on the door 300 being closed. Whether the at least one door 300 is opened may be detected by the door open/close sensor 195.

In addition, the processor 191 may determine whether the content is a real-time video, and may determine the content as the stop target, based on the content not being the real-time video.

In addition, the processor 191 may determine that the content is not the real-time video based on the content being stored in the memory 192.

In addition, the processor 191 may determine that the content is the real-time video, based on playback data of the content including reference data.

In addition, the processor 191 may switch the display 200 to a power saving mode, based on the content being the real-time video and the at least one door 300 being opened.

In addition, the processor 191 may determine whether the content includes a video, and may determine the content as the stop target based on the content including the video.

In addition, the processor 191 may determine the content as the stop target, based on the amount of pixel data change of the content including the video being greater than or equal to a reference value.

In addition, the processor 191 may determine that the display 200 is abnormally terminated, based on the display 200 being turned off in a state where the at least one door 300 is closed. The processor 191 may store playback data at an end time point of the content in the memory 192, based on the display 200 being abnormally terminated, may determine whether the content is the stop target based on the playback data, and may play the content from the end time point based on the content being the stop target and the door 300 being closed.

The processor 191 may include a core that performs logic and arithmetic operations, and a register that stores the computed data.

As such, the controller 190 may process data collected from the sensors and may control the components of the refrigerator 1 based on the data processing. In particular, the controller 190 may provide various conveniences to a user, such as video playback, through the display 200.

However, when a user watches a video through the display 200, the watching is interrupted by the opening and closing of the door 300. Specifically, while the user is watching the video through the display 200 provided on the refrigerator door 300, the video continues to play even when the door 300 of the refrigerator 1 is opened. As a result, the user may miss a portion of the video until the door 300 is closed.

That is, when the user who has been watching the video opens the door 300, the user's gaze is directed toward the storage compartment of the refrigerator 1, and thus the user cannot watch the video. Accordingly, the user has to press a pause button and press a video restart button after closing the refrigerator door 300, which is inconvenient. Furthermore, when a different user other than the user who has been watching the video opens the door 300, the display 200 is outside the user's view, and the user who has been watching the video misses a portion of the video.

An embodiment related thereto is described below in detail with reference to FIG. 4.

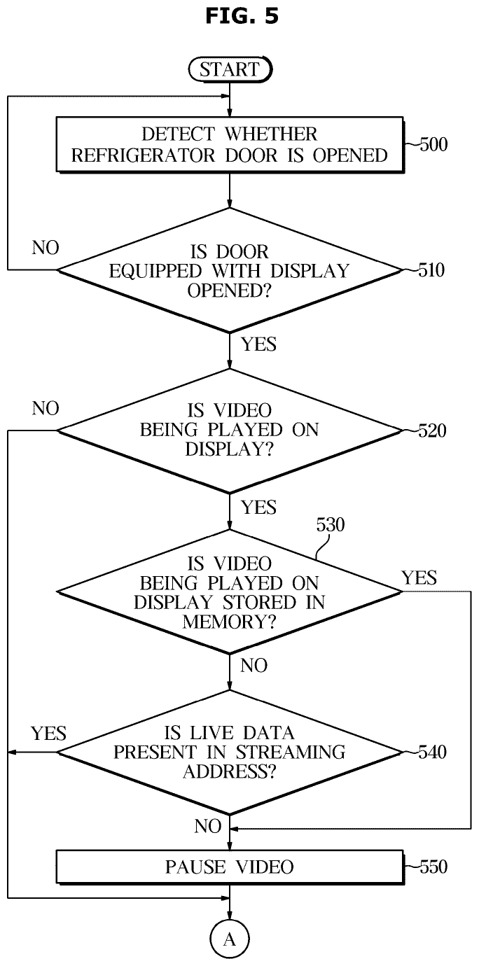

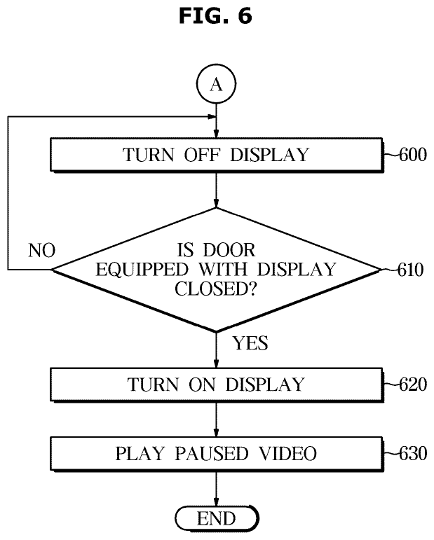

FIG. 4 is a view illustrating a live video is played on a display of a refrigerator according to an embodiment. FIG. 5 is a flowchart illustrating operations of determining whether a live video is played on a display of a refrigerator according to an embodiment. FIG. 6 is a flowchart illustrating operations of determining whether the live video is played on the display of the refrigerator according to an embodiment, in continuation from FIG. 5.

Referring to FIG. 4, the processor 191 may control the display 200 provided on the door 300 of the refrigerator 1 to display a video. Specifically, the processor 191 may display a video stored in the memory 192 of the refrigerator 1 or a video received from an external device (e.g., a user device or a server) through the communication circuitry 180.

In this instance, the processor 191 may determine whether the video displayed on the display 200 is a stop target to be stopped when the door 300 is opened.

Specifically, in a case where the video displayed on the display 200 is a live video, the video cannot be stopped, and thus the processor 191 may determine that the video is not the stop target to be stopped in response to the opening of the door 300. That is, as shown in “a” of FIG. 4, in a case where a visual indicator indicating a live video (e.g., the phrase ‘LIVE’) is displayed on the display and the door 300 of the refrigerator 1 is opened, the processor 191 may determine that the video displayed on the display 200 is a live video, and may only turn off the display 200 without pausing the video to reduce power consumption.

Referring to FIG. 5, the processor 191 may detect whether the refrigerator door is opened by confirming an output value of the door open/close sensor 195 (500). In this instance, the door open/close sensor 195 may be provided in each of the plurality of doors 300, and a determination value about whether the door 300 is opened may be received from the door open/close sensor 195 provided on each door 300.

In addition, the door open/close sensor 195 provided on each door 300 may transmit information about whether each door 300 is opened to the processor 191, and thus the processor 191 may determine whether the door 300 equipped with the display 200 is opened or closed.

Accordingly, the processor 191 may determine whether the door 300 equipped with the display 200 is opened (510). For example, in a case where the processor 191 receives a value of 1 from the door open/close sensor 195 provided on the door 300 equipped with the display 200, the processor 191 may determine that the door 300 equipped with the display 200 is opened.

Based on determining that the door 300 equipped with the display 200 is opened (Yes in operation 510), the processor 191 may determine whether a video is being played on the display 200 (520). Whether a video is being played on the display 200 may be determined based on receiving a video playback signal from the memory 192 or the communication circuitry 180.

The processor 191 may determine whether the video being played on the display 200 is a video stored in the memory 192 (530). That is, the processor 191 may determine whether the video being played on the display 200 is the video stored in the memory 192 of the refrigerator 1 or the user device based on playback data of the video. In a case where the video is stored in the memory 192 of the refrigerator 1 or the user device, the processor 191 may determine that the video being played on the display 200 is a stored video, not a live video.

Based on determining that the video being played on the display 200 is not a video stored in the memory 192 of the refrigerator 1 or the user device, the processor 191 may determine whether live data is present in a streaming address based on the video playback data (540).

That is, the processor 191 may determine whether the live data is present in the video playback data that includes the streaming address of the video being played on the display 200, protocol information of the streaming address, playback time, and capacity. Here, the live data may be in the form of a flag indicating that the video is a live video, and in a case where the flag is 1, indicating that the video is a live video, and in a case where the flag is 0, indicating that the video is a recorded video that is non-live.

Based on determining that the video being played on the display 200 is the video stored in the memory 192 (Yes in operation 530) or that live data is not present in the streaming address (No in operation 540), the processor 191 may determine that the video is a stop target and may pause the video (550).

In addition, based on determining that the video being played is a live video that does not need to be paused (Yes in operation 540), the processor 191 may turn off the display 200 without pausing the video as illustrated in FIG. 6 (600). Turning off the display 200 may include turning off the display panel 220.

That is, referring to FIG. 6, after the display 200 is turned off, the processor 191 may determine whether the door 300 equipped with the display 200 is closed (610). In this instance, the processor 191 may use a determination value of the door open/close sensor 195 to determine whether the door 300 equipped with the display 200 is closed in the same manner as the operations of determining whether the door 300 equipped with the display 200 is opened in FIG. 5.

That is, the door open/close sensor 195 may determine that the door 300 is closed in a case where a distance between the main body 10 and the door 300 of the refrigerator 1 is less than or equal to a preset reference value, and may transmit a corresponding determination value to the processor 191.

Based on determining that the door 300 equipped with the display 200 is closed (Yes in operation 610), the processor 191 may turn on the display 200 (620). In addition, the processor 191 may play the paused video from the paused point (630). In this instance, turning on the display 200 and playing the paused video may be performed simultaneously.

Accordingly, the refrigerator 1 according to an embodiment may determine whether the video is a stop target that may be stopped, and when a user opens and closes the door 300 of the refrigerator 1, may automatically pause and play the paused video that is the stop target, thereby allowing the user to continuously watch the video.

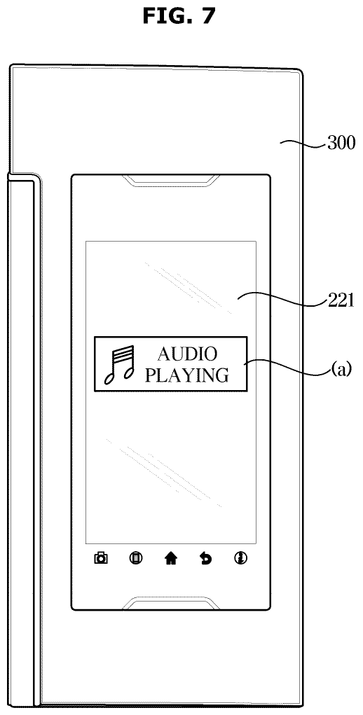

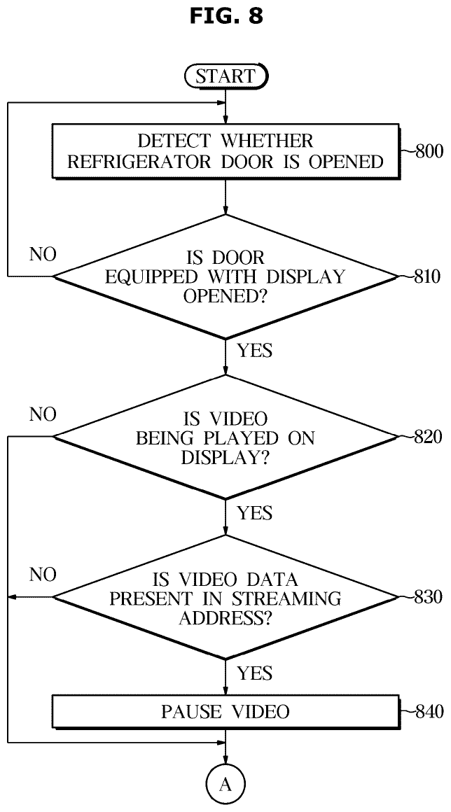

FIG. 7 is a view illustrating audio is played on a display of a refrigerator according to an embodiment. FIG. 8 is a flowchart illustrating operations of determining whether a video is played on a display of a refrigerator according to an embodiment.

Referring to FIG. 7, the processor 191 may control the display 200 provided on the door 300 of the refrigerator 1 to display a video. Specifically, the processor 191 may display a video stored in the memory 192 of the refrigerator 1 or a video received from an external device (e.g., a user device or a server) through the communication circuitry 180.

In this instance, the processor 191 may determine whether the video displayed on the display 200 is a stop target to be stopped when the door 300 is opened.

Specifically, in a case where the video displayed on the display 200 is an audio image without a video, stopping the video is not necessary, and thus the processor 191 may determine that the audio image is not a stop target to be stopped in response to the opening of the door 300.

That is, as shown in “a” of FIG. 7, in a case where a visual indicator (e.g., the phrase ‘AUDIO PLAYING’) indicating that the image only includes audio is displayed on the display, the processor 191 may determine that the video displayed on the display 200 is an audio image that does not include video, and may only turn off the display 200 without pausing the video to reduce power consumption.

Referring to FIG. 8, the processor 191 may detect whether the refrigerator door is opened by confirming an output value of the door open/close sensor 195 (800). Accordingly, the processor 191 may determine whether the door 300 equipped with the display 200 is opened (810).

Based on determining that the door 300 equipped with the display 200 is opened (Yes in operation 810), the processor 191 may determine whether a video is being played on the display 200 (820). Whether a video is being played on the display 200 may be determined based on receiving a video playback signal from the memory 192 or the communication circuitry 180.

The processor 191 may determine whether video data is present in a streaming address based on video playback data (830).

That is, the processor 191 may determine whether the video data is present in the video playback data that includes data about whether the video being played on the display 200 includes video or audio, or the like. In this instance, the video data is in the form of a flag indicating whether the video includes video, and in a case where the flag is 1, indicating that the video includes video, and in a case where the flag is 0, indicating that the video includes only audio without video.

Based on determining that the video data is present in the streaming address of the video being played on the display 200 (Yes in operation 830), the processor 191 may determine that the video is a stop target and may pause the video (840).

In addition, based on determining that the video is an audio image that does not need to be paused (No in operation 830), the processor 191 may turn off the display 200 without pausing the video as illustrated in FIG. 6 (600).

In the refrigerator 1 according to an embodiment, playing the video or turning on the display 200 after turning off the display 200 is the same as in FIG. 6, and thus redundant descriptions are omitted.

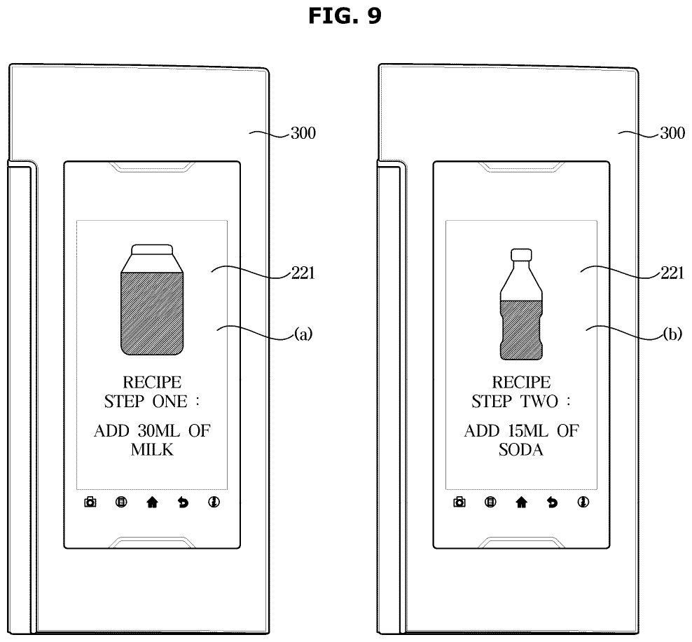

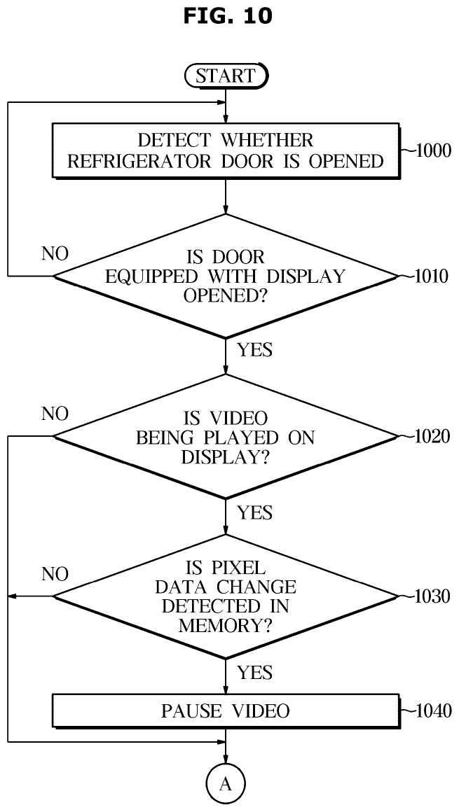

FIG. 9 is a view illustrating a change in image content displayed on a display of a refrigerator according to an embodiment. FIG. 10 is a flowchart illustrating operations of determining whether content of an image displayed on a display of a refrigerator is changed according to an embodiment.

Referring to FIG. 9, the processor 191 may control the display 200 provided on the door 300 of the refrigerator 1 to display an image.

Specifically, the processor 191 may display a video stored in the memory 192 of the refrigerator 1 or an image received from an external device (e.g., a user device or a server) through the communication circuitry 180.

In this instance, the processor 191 may determine whether the video displayed on the display 200 is a stop target to be stopped when the door 300 is opened.

Specifically, even though the video displayed on the display 200 includes video, in a case where the amount of pixel data change of the video is less than a reference value, stopping the video is not necessary, and thus the processor 191 may determine that the video is not a stop target to be stopped in response to the opening of the door 300.

That is, as shown in FIG. 9, in a case where a still image (“a” of FIG. 9) is being played on the display 200 for a predetermined period of time, the processor 191 may determine that the still image is not a stop target to be stopped in response to the opening of the door 300 because the amount of pixel data change of the image is less than the reference value.

That is, in a case where the video displayed on the display 200 consists only of a still image and the amount of pixel data change is less than the reference value, the processor 191 may determine that the video is not a stop target to be stopped in response to the opening of the door 300.

However, as shown in FIG. 9, in a case where the still image (“a” of FIG. 9) is played on the display 200 for a predetermined period of time and then another still image (“b” of FIG. 9) is played, the amount of pixel data change is greater than or equal to the reference value, and thus the processor 191 may determine the video as a stop target to be stopped in response to the opening of the door 300.

That is, in a case where the video displayed on the display 200 consists of two or more consecutive still images and the amount of pixel data change is greater than or equal to the reference value, the processor 191 may determine the video as a stop target to be stopped in response to the opening of the door 300.

Referring to FIG. 10, the processor 191 may detect whether the refrigerator door is opened by confirming an output value of the door open/close sensor 195 (1000). Accordingly, the processor 191 may determine whether the door 300 equipped with the display 200 is opened (1010).

Based on determining that the door 300 equipped with the display 200 is opened (Yes in operation 1010), the processor 191 may determine whether a video is being played on the display 200 (1020). Whether a video is being played on the display 200 may be determined based on receiving a video playback signal from the memory 192 or the communication circuitry 180.

The processor 191 may determine whether the amount of pixel data change is greater than or equal to a reference value in video data stored in the memory 192 (1030).

Based on determining that the amount of pixel data change in the data of the video being played on the display 200 is greater than or equal to the reference value (Yes in operation 1030), the processor 191 may determine that the video is a stop target and may pause the video (1040).

In addition, based on determining that the amount of pixel data change in the data of the video is less than the reference value (No in operation 1030), the processor 191 may turn off the display 200 without pausing the video as illustrated in FIG. 6 (600).

In the refrigerator 1 according to an embodiment, playing the video or turning on the display 200 after turning off the display 200 is the same as in FIG. 6, and thus redundant descriptions are omitted.

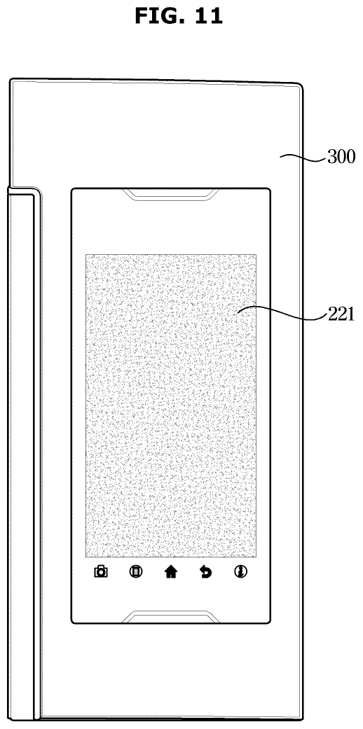

FIG. 11 is a view illustrating an abnormal termination of a display of a refrigerator according to an embodiment.

Referring to FIG. 11, the processor 191 may control the display 200 provided on the door 300 of the refrigerator 1 to display a video. However, the display 200 may be abnormally terminated due to impact or power outage.

Even in this case, the processor 191 may determine whether the video is a stop target to be stopped in response to an opening of the door 300 to allow the video to be played from a paused point.

Specifically, as described above, in a case where the video displayed on the display 200 is a live video, an image that includes only audio, or a still image even in a case of including a video, stopping the video is not necessary, and thus the processor 191 may determine that the video is not a stop target to be stopped in response to the opening of the door 300.

Thereafter, based on determining that the video immediately before the abnormal termination of the display 200 is the stop target, the processor 191 may store playback data at an end time point, and when the door 300 is closed, may play the video from the end time point.

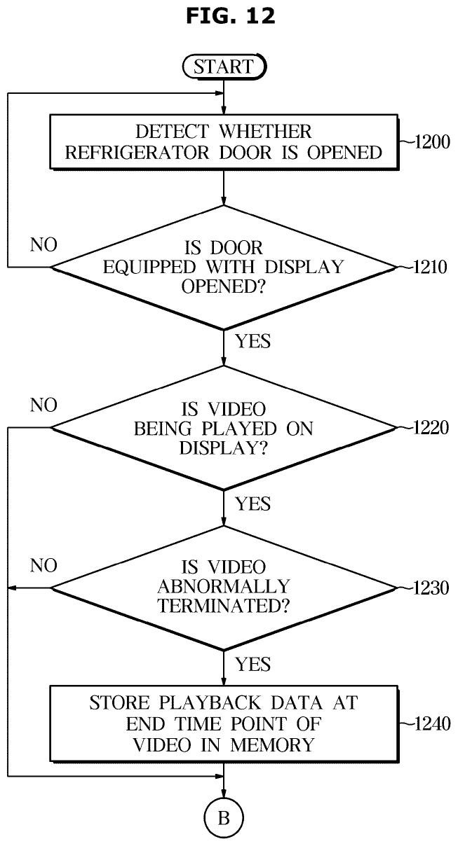

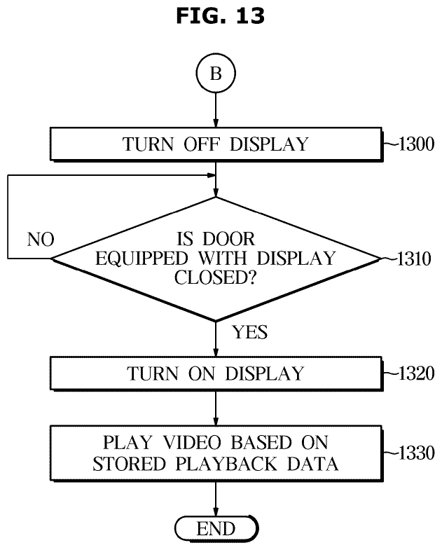

Referring to FIG. 12 and FIG. 13, the processor 191 may detect whether the refrigerator door is opened by confirming an output value of the door open/close sensor 195 (1200). Accordingly, the processor 191 may determine whether the door 300 equipped with the display 200 is opened (1210).

Based on determining that the door 300 equipped with the display 200 is opened (Yes in operation 1210), the processor 191 may determine whether a video is being played on the display 200 (1220). Whether a video is being played on the display 200 may be determined based on receiving a video playback signal from the memory 192 or the communication circuitry 180.

The processor 191 may determine whether the display 200 is turned off in a state where the door 300 is closed (1230). That is, in a case where the display 200 is turned off without user operation in a state where the door 300 is closed, the processor 191 may determine the above as an abnormal termination due to impact or power outage.

Thereafter, the processor 191 may determine whether the video immediately before the display 200 is turned off is a stop target, and based on determining that the video is the stop target, the processor 191 may store playback data at an end time point of the video in the memory 192 (1240).

In this instance, the playback data at the end time point of the video may include a source address of the video, a local file path, and a playback time.

Referring to FIG. 13, the processor 191 may turn off the display 200 (1300). However, in a case where the display 200 is turned off together with the video ending, the processor 191 may omit the operation of turning off the display 200.

Thereafter, after the display 200 is turned off, the processor 191 may determine whether the door 300 equipped with the display 200 is closed (1310). In this instance, the processor 191 may use a determination value of the door open/close sensor 195 to determine whether the door 300 equipped with the display 200 is closed in the same manner as the operations of determining whether the door 300 equipped with the display 200 is opened in FIG. 6.

Based on determining that the door 300 equipped with the display 200 is closed (Yes in operation 1310), the processor 191 may turn on the display 200 (1320). In addition, the processor 191 may play the paused video from the video end time based on the playback data stored in the memory 192 (1330). However, in this instance, turning on the display 200 and playing the paused video may be performed simultaneously.

Accordingly, even in a case where the display 200 is abnormally terminated, the refrigerator 1 according to an embodiment may determine whether the video is a stop target that may be stopped, and when a user opens and closes the door 300 of the refrigerator 1, may automatically pause and play the paused video that is the stop target, thereby allowing the user to continuously watch the video.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be read only memory (ROM), random access memory (RAM), a magnetic tape, a magnetic disc, a flash memory, an optical data storage device, etc.

In addition, the computer-readable recording medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the ‘non-transitory storage medium’ may include a buffer that temporarily stores data.

The methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product (e.g., downloadable app) may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

What is claimed is:

1. A refrigerator, comprising:
a main body including a storage compartment;
at least one door coupled to the main body to open or close the storage compartment;
a display configured to display content, the at least one door having the display;
a door sensor configured to detect whether the at least one door is opened or closed; and
a processor configured to:
determine whether the content being played on the display is a stop target in response to detecting that the at least one door is opened;
pause the content being played in response to determining that the content being played is the stop target; and
resume playing the paused content from a paused point in response to detecting that the at least one door is closed.

2. The refrigerator of claim 1, wherein the processor is further configured to determine whether the content is a real-time video, and determine the content as the stop target in response to determining that the content is not the real-time video.

3. The refrigerator of claim 2, further comprising:
a memory configured to store the content,
wherein the processor is further configured to determine whether the content is the real-time video based on the content being stored in the memory.

4. The refrigerator of claim 2, wherein the processor is further configured to determine that the content is the real-time video based on playback data of the content including reference data.

5. The refrigerator of claim 2, wherein the processor is further configured to switch the display to a power saving mode in response to determining that the content is the real-time video and detecting that the at least one door is opened.

6. The refrigerator of claim 1, wherein the processor is further configured to determine whether the content includes a video, and determine that the content as the stop target in response to determining that the content includes the video.

7. The refrigerator of claim 6, wherein the processor is further configured to determine that the content as the stop target, based on an amount of pixel data change of the content including the video being greater than or equal to a reference value.

8. The refrigerator of claim 1, wherein the processor is further configured to determine that the display is abnormally terminated, based on the display being turned off in a state where the at least one door is closed.

9. The refrigerator of claim 8, further comprising a memory configured to store the content,
wherein the processor is further configured to store playback data at an end time point of the stored content in the memory in response to determining that the display is abnormally terminated.

10. The refrigerator of claim 9, wherein the processor is further configured to determine whether the content is the stop target based on the playback data, and play the content from the end time point in response to determining that the content is the stop target and detecting that the at least one door is closed.

11. A method for controlling a refrigerator comprising a main body including a storage compartment, at least one door coupled to the main body to open or close the storage compartment, a display configured to display content, the at least one door having the display; and a door sensor configured to detect whether the at least one door is opened or closed, the method comprising:
determining whether the content being played on the display is a stop target in response to determining that the at least one door is opened;
pausing the content being played in response to determining that the content is the stop target; and
resume playing the paused content from a paused point in response to determining that the at least one door is closed.

12. The method of claim 11, wherein the determining of whether the content is the stop target comprises determining whether the content is a real-time video, and determining the content as the stop target in response to determining that the content is not the real-time video.

13. The method of claim 12, wherein the determining of whether the content is the real-time video comprises determining that the content is not the real-time video based on the content being stored in a memory.

14. The method of claim 12, wherein the determining of whether the content is the real-time video comprises determining that the content is the real-time video based on playback data of the content including reference data.

15. The method of claim 12, further comprising:
switching the display to a power saving mode based on the determining that the content is the real-time video and the detecting that the at least one door is opened.

16. The method of claim 12, wherein the determining of whether the content is the stop target comprises determining whether the content includes a video and determining that the content as the stop target in response to determining that the content includes the video.

17. The method of claim 16, wherein the determining of whether the content is the stop target further comprises determining that the content as the stop target based on an amount of pixel data change of the content including in the video being greater than or equal to a reference value.

18. The method of claim 12, further comprising determining whether the display is abnormally terminated based on the display being turned off in a state where the at least one door is closed.

19. The method of claim 18, further comprising storing playback data at an end time point of the content in response to determining that the display is abnormally terminated.

20. The method of claim 19, further comprises determining whether the content is the stop target based on the playback data, and playing the content from the end time point in response to determining that the content is the stop target and detecting that the at least one door is closed.
